(19) United States
(12) Patent Application Publication
(10) Pub. No.: US 2004/0105413 A1
(43) Pub. Date: Jun. 3, 2004

(54) System and method for tight inter-working between wireless local area network (WLAN) and universal mobile telecommunication systems (UMTS)

(75) Inventors: Narayan Parappil Menon, Old Bethpage, NY (US); Prabhakar R. Chitrapu, Blue Bell, PA (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE

(21) Appl. No.: 10/609,925

(22) Filed: Jun. 30, 2003

Related U.S. Application Data
(60) Provisional application No. 60/393,411, filed on Jul. 2, 2002.

(51) Int. Cl. H04Q 7/24

(52) U.S. Cl. 370/338; 370/466

(57) ABSTRACT

In a system having a PLMN and a WLAN IP GW, an Iur interface providing handover between a PLMN and the WIP-GW. Mobile internet protocol (Mobile IP) provides session management and data tunneling between the PLMN (home agent) and the WLAN. The WIP-GW functions as the foreign agent toward the PLMN. Services are provided by the PLMN MIP over DIAMETER for registration, authentication and subscriber management, working into the HLR/HSS and the CGF in the PLMN. The use of a single architecture to support the loose inter-working scenarios is such that the architecture minus the Iur interface and MIP becomes a loose inter-working architecture. The UMTS PLMN billing platform is made via the DIAMETER/UMTS inter-working. Authentication is provided by the UMTS PLMN HSS/HLR. The architecture concept can be broadened to cover the inter-working of other access technologies with UMTS.

### CROSS REFERENCE TO RELATED APPLICATION(S)

This application claims priority from provisional application Ser. No. 60/393,411 filed Jul. 2, 2002, which is incorporated by reference as if fully set forth.

### FIELD OF INVENTION

The present invention relates to UMTS systems. More particularly the present invention relates to a system and method for tight inter-working between WLAN and UMTS systems.

### BACKGROUND

There exists a need for system architecture capable of providing tight inter-working between WLAN and UMTS systems and having an architecture capable of supporting:

handover between the two systems;

session management and continuity as terminals handover between the two systems; and

loose inter-working roaming scenarios between the two systems.

### SUMMARY

The WLAN and UMTS technologies are effectively combined to inter-work and support a tight inter-working scenario. The UMTS Iur interface is employed for lossless handover, mobile Internal Protocol (IP) is utilized for session management and continuity and DIAMETER protocol signaling is employed for authentication and billing.

### BRIEF DESCRIPTION OF THE DRAWING

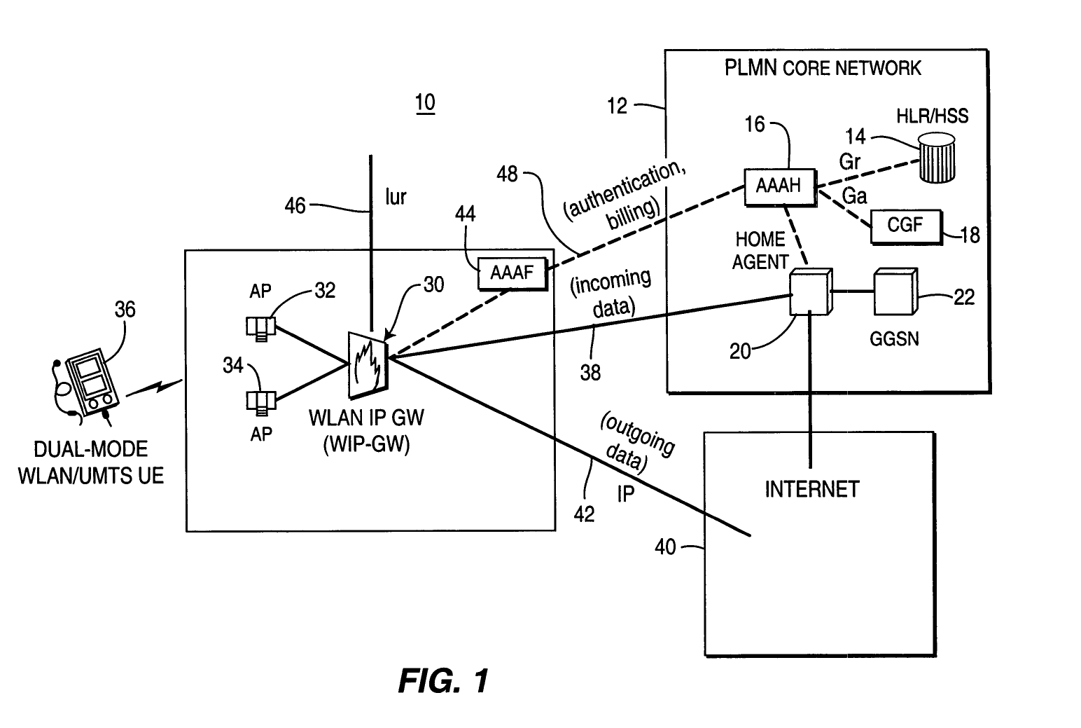

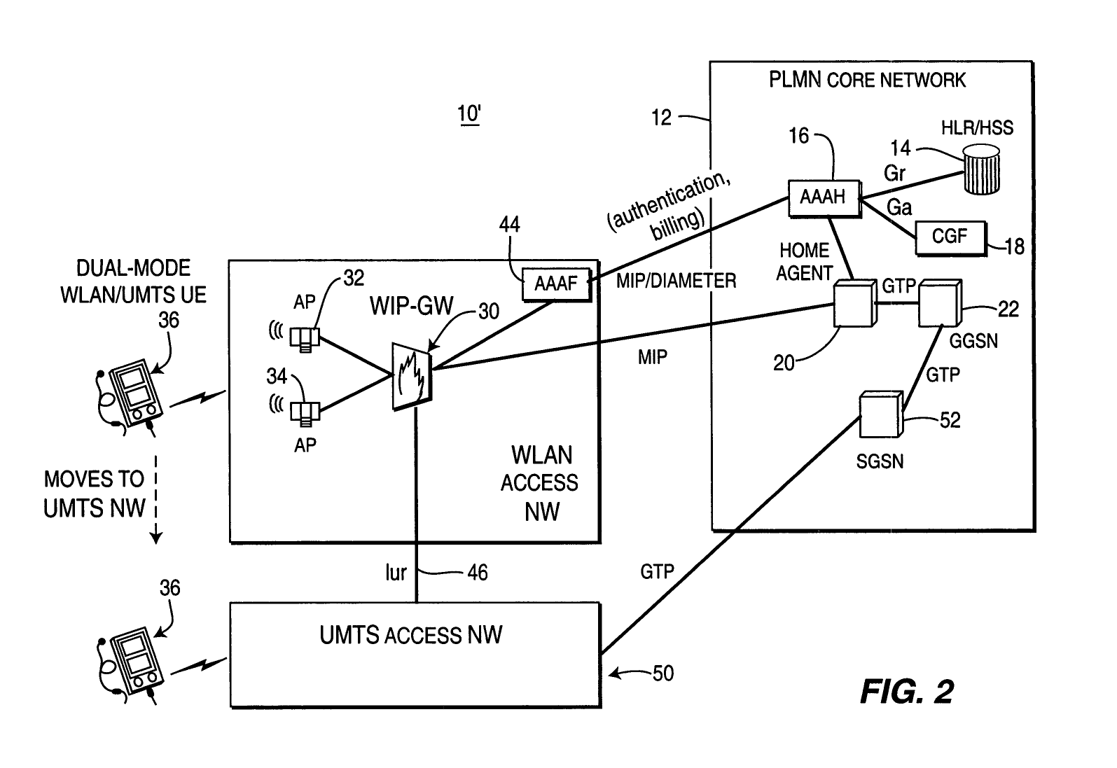

The FIGS. 1 and 2 are system architecture diagrams of WLAN and UMTS networks which embody the principles of the present invention.

### DETAILED DESCRIPTION OF THE INVENTION AND PREFERRED EMBODIMENTS THEREOF

FIG. 1 shows a system architecture 10 comprising a public land mobile network (PLMN) network 12 which includes a home location register/home subscriber server (HLR/HSS) 14, an authentication authorization and accounting home facility (AAAH) 16, a charging gateway function (CGF) 18, a home agent 20 and a general packet radio service support node (GGSN) 22.

A wireless local area network internet protocol gateway (WLAN IP GW), i.e WIP-GW 30, incorporating a firewall, establishes signaling and data interface with two APs, for example the APs 32 and 34. The user equipment (UE) 36 is preferably a dual mode WLAN/UMTS UE.

Data flow in the system shown is as follows: There is a mobile internet protocol (MIP) interface between WIP-GW 30 and the home agent 20 of PLMN 12. WIP-GW 30 combines the functions of the mobile internet protocol (MIP) foreign agent with some radio network controller (RNC) functions. WIP-GW 30 appears to PLMN 12 as a foreign agent, and to the APs as a WLAN Radio Network Controller (RNC). Incoming data is tunneled between PLMN (the home agent) 12 and the WLAN (WIP-GW) 30 as represented by incoming data line 38. Outgoing data flows directly from WIP-GW 30 to the internet 40 as represented by outgoing internet protocol (IP) data line 42.

The PLMN 12 provides the services of authentication and subscriber management using the HSS/HLR 14 of PLMN 12. DIAMETER is an IP domain protocol that handles authorization, authentication and accounting functions in an IP network. The use of DIAMETER in this architecture allows IP-based authentication, authorization and accounting (AAA) procedures to run between the WIP-GW and the PLMN. Since the PLMN is essentially a UMTS network, the node providing the authentication and authorization procedures in the PLMN is the HSS/HLR, and the PLMN node providing accounting is the Charging Gateway Function (CGF). The HLR/HSS and CGF support UMTS procedures and signaling to facilitate these functions. The AAAH provides the signaling inter-working between IP-based AAA procedures and their corresponding UMTS procedures, allowing the AAA functions to and from the HSS/HLR and CGF to be made available to the WLAN access system. Similarly, MIP provides procedures for mobility management in an IP network. In a UMTS network, mobility management procedures for packet-switched data services are handled by the GGSN. The Home Agent in this architecture provides the inter-working between the MIP procedures (running between the WIP-GW and Home Agent) and the UMTS Mobile Application Part (MAP) interface towards the GGSN. MIP/DIAMETER signaling flows from WIP/GW 30 through AAA FOREIGN (AAAF) function 44 and AAA home (AAAH) function 16 to home agent 20. MIP registration messages are encapsulated within the DIAMETER signaling through radio link 48.

AAAH 16 inter-works DIAMETER with mobile application part (MAP) (Gr interface) towards HLR/HSS 14, enabling usage of HSS/HLR for authentication.

AAAH 16 interfaces with the PLMN's charging gateway function (CGF) 18 using GPRS tunneling protocol (GTP) (through the Ga interface) to enable the usage of the PLMN billing servers.

Session continuity between the WLAN and the UMTS PLMN 12 is obtained using MIP (between WIP-GW 30 and Home Agent 20) and GTP (between Home Agent 20 and GGSN 22). The Home Agent 20 provides the inter-working between the two interfaces. Session continuity allows the user's session and IP address to be maintained as the user moves between Access Points, (APs) such as 32 and 34 and between UMTS and WLAN networks. Effectively, the GGSN 22 functions as the anchor point for the data session, as the user moves between these networks. For example, in the architecture 10′, if the user moves from the WLAN access network to a UMTS access network (UMTS Access NW), 50, as shown in FIG. 2, the user's session remains anchored on the GGSN 22, and is hence maintained during the movement. When in the UMTS access NW 50, the UE 36 communicates with the anchor GGSN 22 via the UMTS Radio Access Network (RAN) and the Serving GPRS Support Node (SGSN) element 52 in the PLMN. Handover between WLAN and UMTS PLMN employs the Iur interface represented at 46. The WIP-GW supports the UMTS Iur 46 interface to a Radio Network Controller (RNC) within the UMTS RAN.

What is claimed is:

1. A method providing tight inter-working between a wireless local area network (WLAN) and a universal mobile telecommunications system (UMTS), comprising:
said UMTS and WLAN communicating data directly using mobile internet protocol (MIP) between said UMTS and said WLAN; and
said UMTS and WLAN communicating data through the internet using internet protocol (IP).

2. A method for handover of a user equipment (UE) communications between a wireless local area network (WLAN) and a universal mobile telecommunications system (UMTS), comprising:
said UMTS and WLAN using an Iur interface to support handover therebetween.

3. The method of claim 1 wherein MIP over DIAMETER signaling provides session maintenance between the WLAN and the UMTS as a UE moves between the two systems.

4. The method of claim 1 wherein the UMTS employs public land mobile network billing platforms via DIAMETER-UMTS inter-working.

5. The method of claim 1 wherein the UMTS employs PLMN home location register/home subscriber server for authentication.

6. Apparatus providing tight inter-working between a wireless local area network (WLAN) and a universal mobile telecommunications system (UMTS), comprising:
said UMTS and WLAN each having means for communicating data directly with one another using mobile internet protocol (MIP) between said UMTS and said WLAN; and
said WLAN having means for transferring outgoing data to the internet using internet protocol (IP).

7. The apparatus of claim 6 wherein said WLAN comprises:
means for receiving incoming data from a mobile network.

8. The apparatus of claim 7 wherein said mobile network is a public land mobile network (PLMN).

9. The apparatus of claim 8 wherein in said PLMN comprises a home agent (HA) for tunneling data to an internet protocol gateway (IPGW) provided in said WLAN.

10. The apparatus of claim 9 wherein said HA further communicates with the internet employing IP.

11. The apparatus of claim 8 wherein said PLMN includes authentication, authorization accounting home (AAAH) which communicates authentication with an AAA foreign (AAAF) provided in said WLAN.

12. The apparatus of claim 11 wherein the AAAF provides communication of said AAAH with said WLAN IP GW.

13. The apparatus of claim 8 wherein the AAAH cooperates with the HA and a home location register/home subscriber server (HLR/HSS) to provide AAAH services.

14. Apparatus for handover of a user equipment (UE) between a wireless local area network (WLAN) and a universal mobile telecommunications system (UMTS), comprising:
said UMTS having an Iur interface to support handover with the WLAN.

15. The apparatus of claim 14 wherein means using MIP over DIAMETER signaling provides session maintenance between the WLAN and the UMTS as a UE moves between said WLAN and said UMTS.

16. The apparatus of claim 6 wherein the UMTS employs public land mobile network billing platforms via DIAMETER-UMTS inter-working.

17. The method of claim 6 wherein the UMTS employs a PLMN having a home subscriber server/home locating register (HSS/HLR) for authentication.

18. Apparatus providing tight inter-working between a wireless local area network (WLAN) and a universal mobile telecommunications system (UMTS), comprising:
said UMTS and WLAN each having means for communicating data directly with one another using mobile internet protocol (MIP) between said UMTS and said WLAN; and
said UMTS communicating with said WLAN through an Iur to provide a handover of a user equipment (UE) from one of said UMTS and WLAN to another one of said UMTS and WLAN.
